(19) United States
(12) Patent Application Publication
(10) Pub. No.: US 2003/0095828 A1
(43) Pub. Date: May 22, 2003

(54) Toothpaste dispensing toothbrush adaptable for use with a toothpaste dispenser

(76) Inventor: Theodore R. Hofstedt, Phoenix, AZ (US)

Correspondence Address: WEISS & MOY PC, 4204 NORTH BROWN AVENUE, SCOTTSDALE, AZ, 85251, US

(21) Appl. No.: 10/295,695

(22) Filed: Nov. 15, 2002

Related U.S. Application Data
(60) Provisional application No. 60/332,747, filed on Nov. 16, 2001.

(51) Int. Cl. A47L 13/22; B43M 11/06

(52) U.S. Cl. 401/277; 401/270; 401/183; 401/175

(57) ABSTRACT

A toothbrush which may be coupled to a toothpaste dispensing container has a body member. The body member has a channeling running a length of the body member. The channeling allows toothpaste to flow through the body member. A connector device is formed on a first end of the body member to allow the body member to be coupled to the toothpaste dispenser. A head member is coupled to a second end of the body member. The head member has at least one opening to allow the toothpaste to flow out through the head member. A plurality of bristles are coupled to the head member.

### RELATED APPLICATIONS

This application claims the benefits of the U.S. Provisional Application entitled “A TOOTHPASTE DISPENSING TOOTHBRUSH ADAPTABLE FOR USE WITH A TOOTHPASTE DISPENSER,” filed on Nov. 16, 2001, having a serial No. 60/332,747, and in the name of the same inventor. The provisional application is hereby incorporated by reference into the present application.

### BACKGROUND OF THE INVENTION

1. Field of the Invention

This invention relates to toothbrushes and, more specifically, to a toothbrush which may be easily connected to existing toothpaste dispensing devices and which will dispense the toothpaste from the toothpaste dispensing devices through the bristles of the toothbrush.

2. Description of the Prior Art

Individuals generally clean teeth by placing toothpaste onto a toothbrush. The toothpaste is generally dispensed from a separate toothpaste container onto the toothbrush. The individual will then move the bristles of the toothbrush across his/her teeth in order to remove any build-up on the individual's teeth.

Unfortunately, there are several problems with present toothbrushes and methods of cleaning one's teeth. Present toothbrushes are not designed to adequately clean the surface of the user's teeth. Present toothbrushes do not promote a circular/vertical brush stroke. Current toothbrushes promote a horizontal stroke and ridging. Furthermore, current toothbrushes are not properly angled to allow the user to clean the rear teeth of the user utilizing the proper circular/vertical stroke. Furthermore, present toothbrushes only have bristles on one surface of the toothbrush. Thus, the user may only clean one surface of the mouth at a time.

Due to the hectic pace of today's society, many people don't like to take the time to brush their teeth. Many people don't want to take the time to open a tube of toothpaste, squeeze the toothpaste onto the toothbrush, close the tube of toothpaste, and start brushing one's teeth. Many people are looking for an easier and more time efficient way of cleaning one's teeth.

Therefore, a need existed to provide an improved toothbrush to overcome the above mentioned problems. The improved toothbrush must be angled to reach all areas of the user's mouth. The improved toothbrush must be angled to reach all areas of the user's mouth while using the proper circular/vertical brush stroke. The improved toothbrush must further have additional bristles to allow simultaneous cleaning of different surfaces of the user's mouth. The improved toothbrush must further be able to clean the mouth of the user in a more time efficient manner.

### SUMMARY OF THE INVENTION

In accordance with one embodiment of the present invention, it is an object of the present invention to provide an improved toothbrush.

It is another object of the present invention to provide an improved toothbrush that is angled to reach all areas of the user's mouth.

It is still another object of the present invention to provide an improved toothbrush that allows the user to access and clean the back teeth while utilizing the correct vertical/circular brush stroke.

It is still another object of the present invention to provide an improved toothbrush that has additional bristles to allow simultaneous cleaning of different surfaces of the user's mouth.

It is yet another object of the present invention to provide an improved toothbrush that is able to clean the mouth of the user in a more time efficient manner.

### BRIEF DESCRIPTION OF THE PREFERRED EMBODIMENTS

In accordance with one embodiment of the present invention a toothbrush which may be coupled to a toothpaste dispensing container is disclosed. The toothbrush has a body member. The body member has a channeling running a length of the body member. The channeling allows toothpaste to flow through the body member. A connector device is formed on a first end of the body member to allow the body member to be coupled to the toothpaste dispenser. A head member is coupled to a second end of the body member. The head member has at least one opening to allow the toothpaste to flow out through the head member. A plurality of bristles are coupled to the head member.

In accordance with another embodiment of the present invention a toothbrush which may be coupled to a toothpaste dispensing container is disclosed. The toothbrush has a body member. The body member has a channeling running a length of the body member wherein the channeling allows toothpaste to flow through the body member. A connector device is located on a first end of the body member to allow the body member to be coupled to the toothpaste dispenser. A plurality of openings are located on a second end of the body member. The openings allow the toothpaste to exit the body member. A plurality of bristles are coupled to the body member near the plurality of openings.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The invention itself, as well as a preferred mode of use, and advantages thereof, will best be understood by reference to the following detailed description of illustrated embodiment when read in conjunction with the accompanying drawings, wherein like reference numerals and symbols represent like elements.

FIG. 1 is an elevated perspective view of one embodiment of the toothbrush of the present invention.

FIG. 2 is a cross-sectional side view of the brush section of the toothbrush depicted in FIG. 1.

FIG. 3 is a cross-sectional side view of the head area of the brush section depicted in FIG. 2 taken along lines 3-3 showing the hollow interior of the brush section.

FIG. 4 is side view of the brush section of the toothbrush depicted in FIG. 1 with a majority of the bristles removed.

FIG. 5 is a front view of the brush section of the toothbrush depicted in FIG. 1 with the body of the brush section in a non-angled position.

FIG. 6 is a cross-sectional front view of one embodiment of the handle section of the toothbrush of the present invention.

FIG. 7 is a cross-section top view of the handle section depicted in FIG. 6 taken along lines 7-7.

FIG. 8 is a partial exploded view of the toothbrush of the present invention.

FIG. 9 is a front view of the handle section of the toothbrush of the present invention.

FIG. 10 is a cut away view of a bottom portion of the handle section of the toothbrush of the present invention.

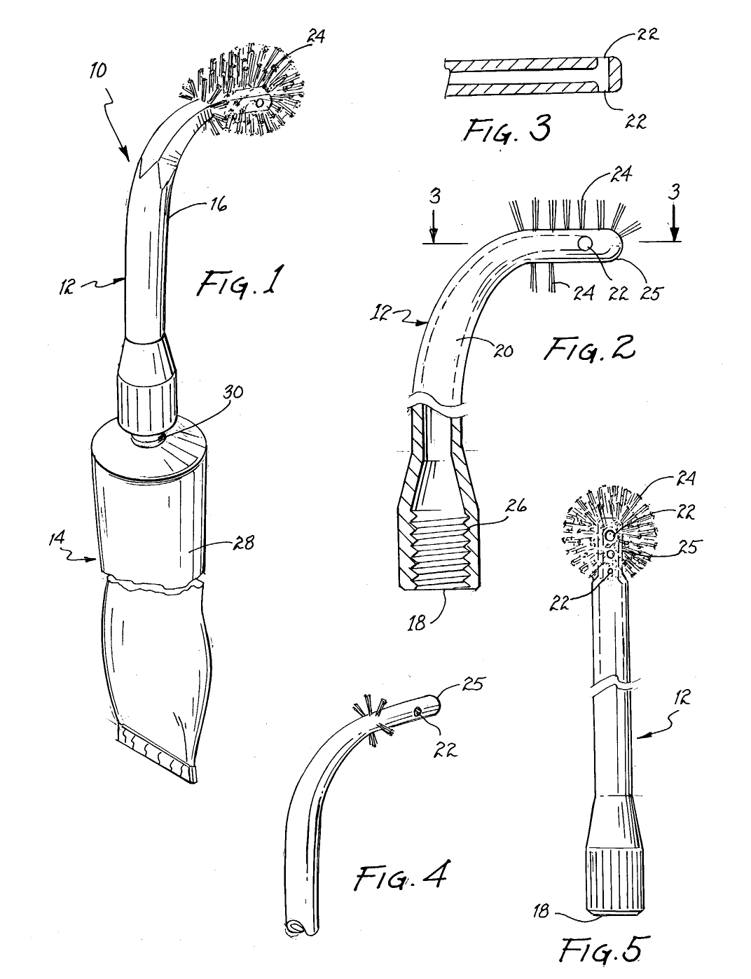

### DETAILED DESCRIPTION OF THE PREFERRED EMBODIMENT

Referring to the Figures wherein like numerals and symbols represent like elements, a toothbrush 10 is shown. The toothbrush 10 is comprised of two main section: the brush section 12 and the handle section 14. It should be noted that the toothbrush 10 may be sold as separate components or as a combination of components. If sold as separate components, the components would be interchangeable.

The brush section 12 is comprised of a tubular body member 16. The tubular body member 16 is semi-flexible but still rigid. The tubular body member 16 is flexible enough so that one can bend the tubular body member 16 but rigid enough so that when the tubular body member 16 is bent, the tubular body member 16 will stay in the bent position. The curvature of the tubular body member 16 will help to offset the brush section 12 from the handle section 14. The curvature will further allow the user to access and clean the back teeth as well as to promote the correct vertical/circular brush stroke.

In accordance with another embodiment of the present invention, the tubular body member 16 is rigid. The tubular body member 16 is the same as described above except that the tubular body member 16 is made of a rigid material. The tubular body member 16 is preformed so as to be bent at a predetermined angle to offset the brush section 12 from the handle section 14 as well as to allow the user to access and clean the back teeth and to promote the correct vertical/circular brush stroke.

At one end of the tubular body member 16 is an opening 18. The opening 18 leads to an internal central channel 20. The central channel 20 runs within the interior of the tubular body member 16. The central channel 20 runs a majority of the length of the tubular body member 16. One or more side channels 22 are fluidly engaged with the central channel 20. The side channels 22 extend out from the central channel 20 and penetrate the exterior surface of the tubular body member 16.

At the end of the tubular body member 16 opposite from the opening 18 are bristles 24. The bristles 24 extend out from the head 25 of the tubular body member 16. The shape of the head 25 may vary. In accordance to one embodiment of the present invention, the head 25 is circular in shape (FIG. 8). The head 25 may further be a rectangular plane or a stem shape (FIG. 4).

As stated above, the bristles will extend out from the head 25. The bristles 24 are standard toothbrush bristles made out of nylon or similar material. The bristles 24 may further come in varying degrees of stiffness (i.e., soft, medium, stiff, etc.). However, unlike conventional toothbrushes, the bristles 24 are located on each side of the head 25 facing opposite directions or the bristles 24 may be located around the entire outer circumference of the top section of tubular body member 16. Present toothbrushes only have bristles located on one surface (top surface) of the toothbrush. By having the bristles 24 facing opposite directions or located around the entire outer circumference of the top section of tubular body member 16, one may brush and clean more than one area of the user's mouth. For example, one may brush the tops of both the upper and lower teeth at the same time. Thus, by having the bristles 24 located around the entire outer circumference of the top section of tubular body member 16, one may be able to clean his/her teeth in an easier and faster manner.

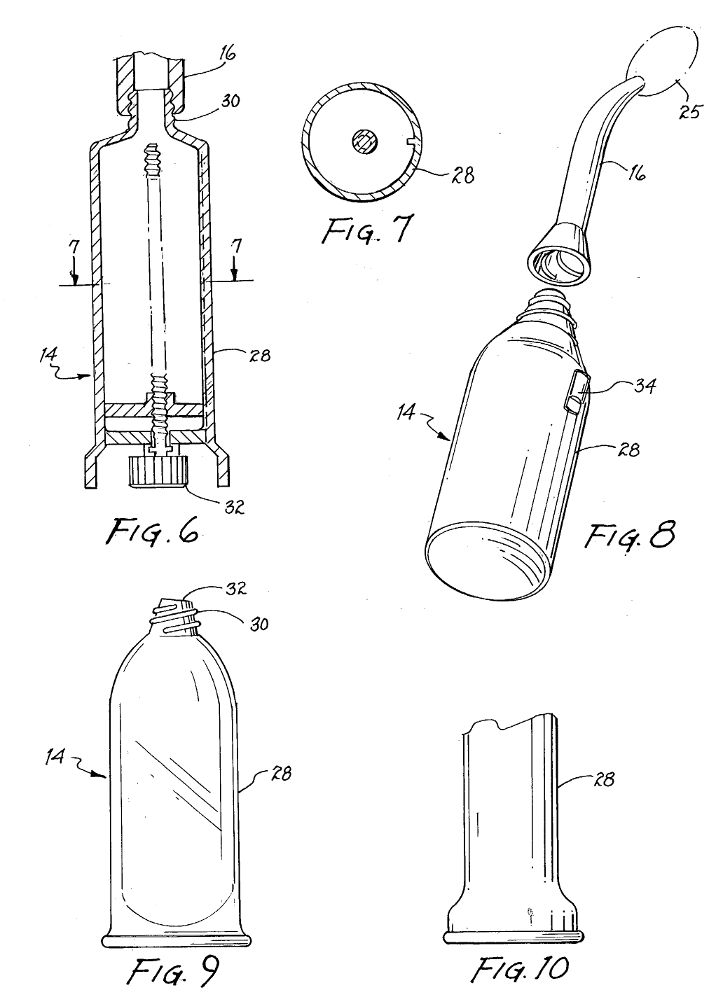

The end of the central channel 20 closest to the opening 18 will have threading 26. The threading 26 will allow the tubular body member 16 to be coupled to a standard toothpaste dispenser 28 (i.e., toothpaste tube, twist type toothpaste dispenser, etc.). As may be seen more clearly in FIG. 9, the threading 26 of the tubular body member 16 will engage the threading 30 located on the output spout 32 of the toothpaste dispenser 28. Once the tubular body member 16 is coupled to the toothpaste dispenser 28, the toothpaste dispenser 28 will function as a handle for toothbrush 10. As stated above, any standard toothpaste dispenser 28 may be used that utilizes a screw top. As may be seen in FIG. 1, a toothpaste tube is used as the standard toothpaste dispenser 28. FIGS. 6-8 show newer cylinder toothpaste tubes as the standard toothpaste dispenser 28. If a cylinder toothpaste tube is used as the toothpaste dispenser 28, the toothbrush 10 may be stood in an upright position for easier storage.

A cap is provided to be placed over the head 25 of the brush section 12. The cap will keep air from entering the central channel 20, the side channels 22, and the toothpaste dispenser 28. The cap will thus prevent the toothpaste from drying out and clogging the toothbrush 10. The cap will further protect the bristles 24 from being damaged while the toothbrush 10 is not being used. A screw in end cap may also be provided. The screw in end cap will fit in the opening 18. The screw in end cap will seal the toothbrush 10 for travel and storage.

In operation, a user will dispense toothpaste from the standard toothpaste dispenser 28. This may be done in several different manners depending on the type of standard toothpaste dispenser 28 being used. As may be seen in FIG. 1, if the toothpaste dispenser 28 is a tube, the user will squeeze the tube. If the toothpaste dispenser 28 is a twist type dispenser (FIG. 6), the user will twist the handle 32 to dispense the toothpaste. If the toothpaste dispenser 28 has a handle dispensing mechanism 34 (FIG. 8), the handle is moved forward to dispense the toothpaste.

The toothpaste will then travel from the toothpaste dispenser 28 through the output spout 32. The toothpaste will enter the tubular body member 16 of the brush section 12. The toothpaste will travel through the central channel 20 and out of the side channels 22 onto the bristles 24. The user may then grab the toothpaste dispenser 28 and use it as a handle to brush his/her teeth. The above operation is a simpler and more time efficient method for brushing one's teeth. Time and energy is saved since the toothpaste dispenser and the toothbrush are all one mechanism.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A toothbrush which may be coupled to a toothpaste dispensing container comprising, in combination:
a body member having a channeling running a length of the body member wherein the channeling allows toothpaste to flow through the body member;
a connector device located on a first end of the body member to allow the body member to be coupled to the toothpaste dispenser;
a head member coupled to a second end of the body member wherein the head member has at least one opening to allow the toothpaste to flow out through the head member; and
a plurality of bristles coupled to the head member.

2. A toothbrush which may be coupled to a toothpaste dispensing container in accordance with claim 1 wherein the body member is curved to allow the toothbrush to access and clean teeth in a rear section of a mouth of a user.

3. A toothbrush which may be coupled to a toothpaste dispensing container in accordance with claim 1 wherein the body member is rigid.

4. A toothbrush which may be coupled to a toothpaste dispensing container in accordance with claim 1 wherein the body member is semi-flexible so that one can bend the body member but rigid enough so that when the body member is bent, the body member will stay in the bent position.

5. A toothbrush which may be coupled to a toothpaste dispensing container in accordance with claim 1 wherein the connector is a plurality of ridges formed on an interior section of the first end of the body member for allowing the body member to be screwed onto the toothpaste dispensing container.

6. A toothbrush which may be coupled to a toothpaste dispensing container in accordance with claim 1 wherein the bristles are located on each side of the head member.

7. A toothbrush which may be coupled to a toothpaste dispensing container in accordance with claim 1 wherein the bristles are located on an entire outer circumference of the head member.

8. A toothbrush which may be coupled to a toothpaste dispensing container in accordance with claim 1 wherein the head member has a plurality of openings.

9. A toothbrush which may be coupled to a toothpaste dispensing container comprising, in combination:
a body member which is curved to allow the toothbrush to access and clean teeth in a rear section of a mouth of a user and having a channeling running a length of the body member wherein the channeling allows toothpaste to flow through the body member;
connector device formed on a first end of the body member to allow the body member to be coupled to the toothpaste dispenser wherein the connector is a plurality of ridges formed in an interior section of the first end of the body member for allowing the body member to be screwed onto the toothpaste dispensing container;
a head member coupled to a second end of the body member wherein the head member has at least one opening to allow the toothpaste to flow out through the head member; and
a plurality of bristles coupled to the head member.

10. A toothbrush which may be coupled to a toothpaste dispensing container in accordance with claim 9 wherein the body member is rigid.

11. A toothbrush which may be coupled to a toothpaste dispensing container in accordance with claim 9 wherein the body member is semi-flexible so that one can bend the body member but rigid enough so that when the body member is bent, the body member will stay in the bent position.

12. A toothbrush which may be coupled to a toothpaste dispensing container in accordance with claim 9 wherein the bristles are located on each side of the head member.

13. A toothbrush which may be coupled to a toothpaste dispensing container in accordance with claim 9 wherein the bristles are located on an entire outer circumference of the head member.

14. A toothbrush which may be coupled to a toothpaste dispensing container in accordance with claim 9 wherein the head member has a plurality of openings.

15. A toothbrush which may be coupled to a toothpaste dispensing container comprising, in combination:
a body member having a channeling running a length of the body member wherein the channeling allows toothpaste to flow through the body member;
a connector device located on a first end of the body member to allow the body member to be coupled to the toothpaste dispenser;
a plurality of openings on a second end of the body member for allowing the toothpaste to exit the body member; and
a plurality of bristles coupled to the body member near the plurality of openings.

16. A toothbrush which may be coupled to a toothpaste dispensing container in accordance with claim 15 further comprising a head member coupled to a second end of the body member wherein the head member has at least one opening to allow the toothpaste to flow out through the plurality of openings and out through the head member wherein the plurality of bristles are directly coupled to the head member.

17. A toothbrush which may be coupled to a toothpaste dispensing container in accordance with claim 15 wherein the body member is curved to allow the toothbrush to access and clean teeth in a rear section of a mouth of a user.

18. A toothbrush which may be coupled to a toothpaste dispensing container in accordance with claim 15 wherein the body member is rigid.

19. A toothbrush which may be coupled to a toothpaste dispensing container in accordance with claim 15 wherein the body member is semi-flexible so that one can bend the body member but rigid enough so that when the body member is bent, the body member will stay in the bent position.

20. A toothbrush which may be coupled to a toothpaste dispensing container in accordance with claim 15 wherein the head member has a plurality of openings.
